(19) United States
(12) Patent Application Publication
(10) Pub. No.: US 2010/0117945 A1
(43) Pub. Date: May 13, 2010

(54) COLOR SEQUENCE OFFSET MODULATION METHOD AND DEVICE

(76) Inventors: Chia-Hui CHEN, Taichung County (TW); Chiu-Yuan Huang, Taichung City (TW); Chun-Tsai Chien, Taichung City (TW)

Correspondence Address: Muncy, Geissler, Olds & Lowe, PLLC, P.O. BOX 1364, FAIRFAX, VA, 22038-1364, US

(21) Appl. No.: 12/267,954

(22) Filed: Nov. 10, 2008

(51) Int. Cl. G09G 3/36

(52) U.S. Cl. 345/102

(57) ABSTRACT

The present invention discloses a color sequence offset modulation method and device, which modulates the colored backlights of a multi-color backlight source to have a dark interval in the time points of shifting the colored backlights and makes the dark interval coincide with the close delay interval caused by the delayed response of liquid crystal, whereby the latter colored backlight will not mix with the former colored backlight during the close delay interval, wherefore the present invention can avoid the color deviation caused by color mixing and can present the designed colors correctly.

### FIELD OF THE INVENTION

The present invention relates to a display method and device of a color liquid crystal display, particularly to a color sequence offset modulation method and device, which can prevent from color mixing-induced color deviation and present the designed colors correctly.

### BACKGROUND OF THE INVENTION

In FSC LCD (Field Sequential Color Liquid Crystal Display), multi-color backlights are sequentially emitted and pass through optical liquid crystal gates. FSC LCD opens and closes the liquid crystal optical gates to sequentially generate pure-color fields, and then the visual persistence of human eyes mixes the pure colors to present various colors. Refer to FIG. 1. The timing signal 1 is used to open and close the liquid crystal optical gates. However, the light transmission curve 2 cannot fully reflect the timing signal 1 because the delayed response of liquid crystal molecules. Thus, there are open delays 3 and close delays 4 appearing in the light transmission curve 2.

Refer to FIG. 2. The multi-color backlights 5 includes a red backlight (R) 6, a green backlight (G) 7 and a blue backlight (B) 8, which are sequentially emitted. The liquid crystal optical gate has three light transmission curves 2 (designated by r, g, and b) corresponding to the sequentially-emitted red backlight (R) 6, green backlight (G) 7 and blue backlight (B) 8. The close delays 4 of the light transmission curves 2 extend to the time intervals for the latter-color backlight. In other words, the green backlight 7 appears in a portion of the time interval for the red backlight 6; the blue backlight 8 appears in a portion of the time interval for the green backlight 7; the red backlight 6 appears in a portion of the time interval for the blue backlight 8. Thus, color deviations appear in human eyes. When the liquid crystal optical gate generates other light transmission curves 2 (designated by c, m, and y) to mix two pure color lights, the close delays 4 of the light transmission curves 2 (c, m, and y) also extend to the time intervals for the latter-color backlight. Thus, color deviations also appear in human eyes in the color-mixing case.

### SUMMARY OF THE INVENTION

The primary objective of the present invention is to provide an offset modulation method and device to eliminate color difference and retain the purity of colors, whereby the problem of color deviation is solved.

The present invention proposes a color sequence offset modulation method and device. The device of the present invention comprises a multi-color backlight source, a liquid crystal optical gate and a controller.

The method of the present invention comprises steps:

providing a multi-color backlight source sequentially emitting at least two colored backlights with a dark interval therebetween;

providing a liquid crystal optical gate illuminated by said colored backlights and having a light blocking state and a light permeable state;

providing a timing signal to switch the liquid crystal optical gate into the light blocking state or the light permeable state, whereby the liquid crystal optical gate has a light transmission curve, wherein the light transmission curve has an open delay interval or a close delay interval in the transitions of the light blocking state and the light permeable state, and wherein the timing signal makes the close delay interval coincide with the dark interval lest the latter colored backlight mix with the former colored backlight during the close delay interval.

Therefore, the present invention can prevent from the color difference caused by color mixing during the close delay interval. In a case of needing pure colors, the present invention can avoid the color deviation caused by color mixing. In a case of needing mixed colors, the present invention can present the designed colors correctly.

### BRIEF DESCRIPTION OF THE DRAWINGS

FIG. 1 is a diagram showing the timing signal and transmission curve of a conventional technology;

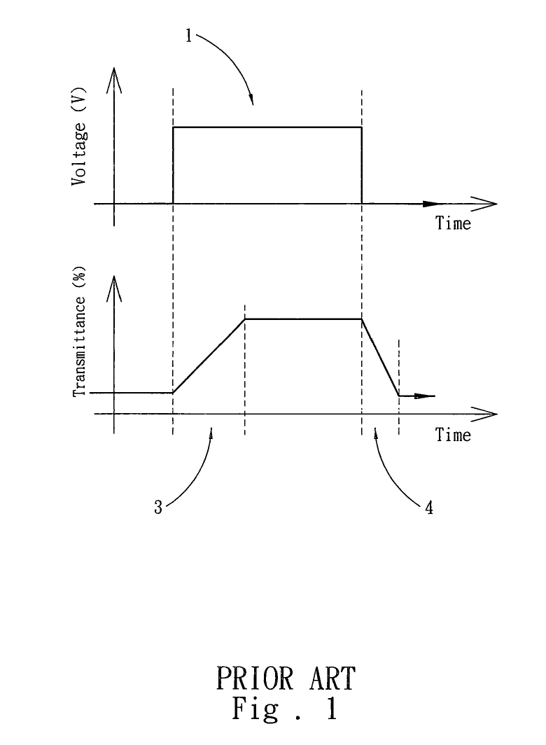

FIG. 2 is a diagram showing the timing charts of a conventional FSC LCD.

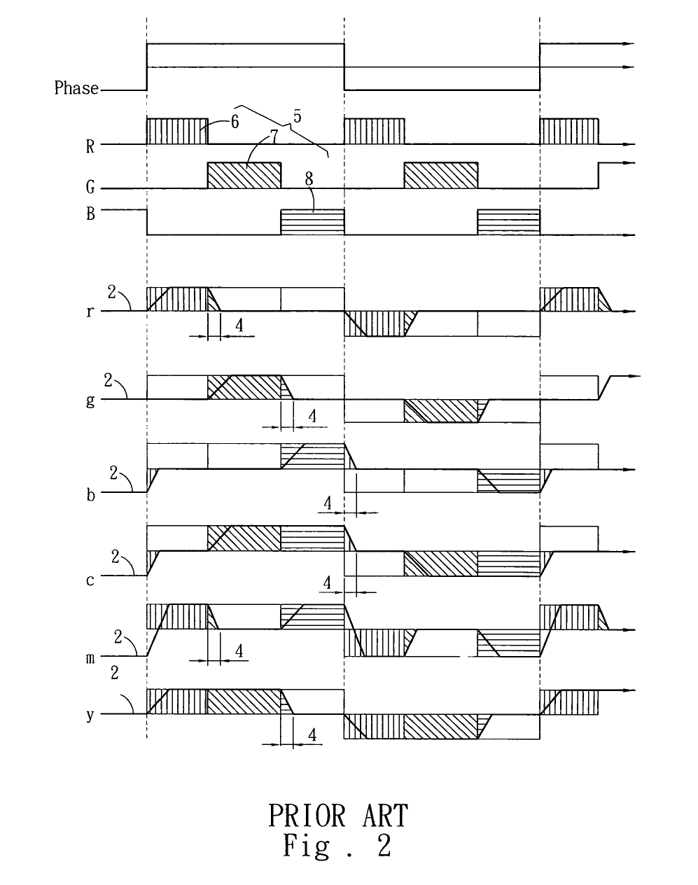

FIG. 3 is a diagram schematically showing a color sequence offset modulation device according to a first embodiment of the present invention;

FIG. 4 is a diagram showing the timing charts of a FSC LCD using a color sequence offset modulation device according to a first embodiment of the present invention; and

FIG. 5 is a diagram showing the timing charts of a FSC LCD using a color sequence offset modulation device according to a second embodiment of the present invention.

### DETAILED DESCRIPTION OF THE PREFERRED EMBODIMENTS

Below, the technical contents of the present invention are described in detail in cooperation with the drawings.

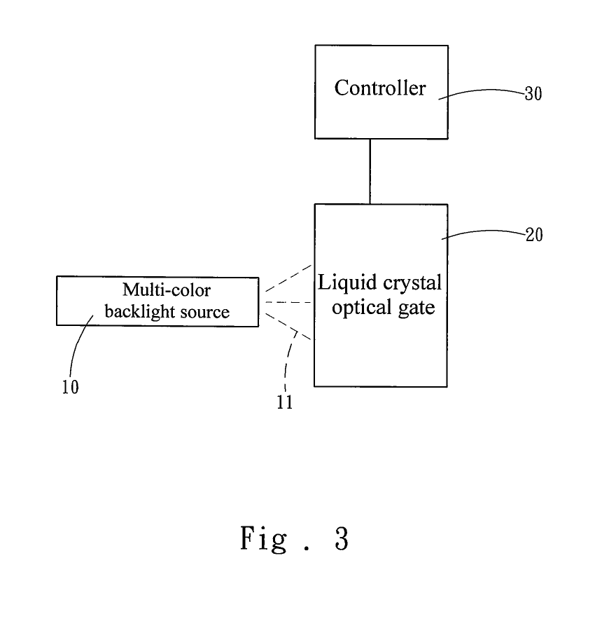

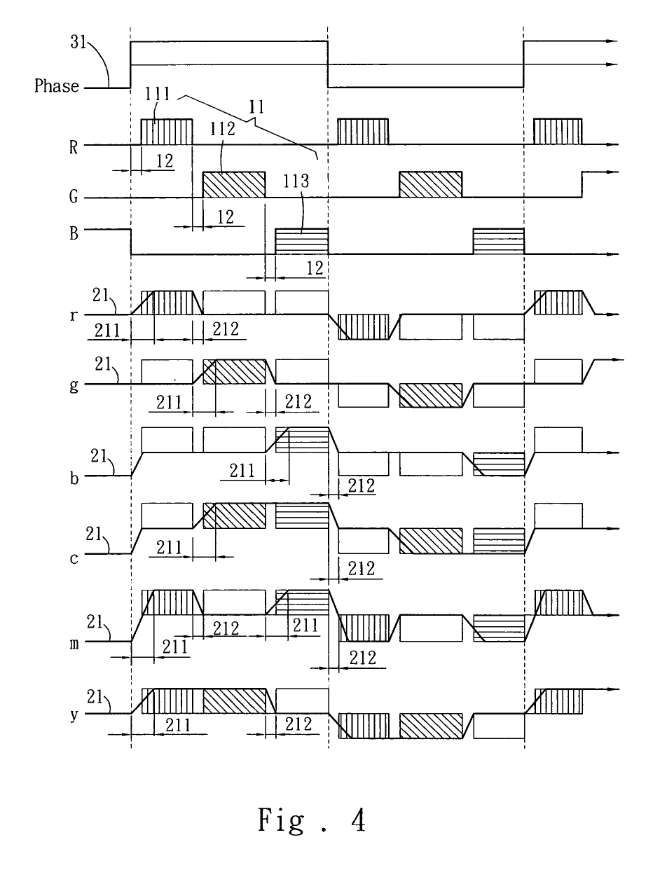

Refer to FIG. 3 and FIG. 4. In a first embodiment, the device of the present invention comprises a multi-color backlight source 10, a liquid crystal optical gate 20 and a controller 30. The multi-color backlight source 10 is arranged near the liquid crystal optical gate 20, and the controller 30 is electrically coupled to the liquid crystal optical gate 20.

The multi-color backlight source 10 emits at least two colored backlights 11 with a dark interval 12 therebetween. The colored backlights 11 include a red backlight 111, a green backlight 112 and a blue backlight 113. The colored backlight 11 may have the dark interval 12 at the instant that the multi-color backlight source 10 begins to emit the colored backlight 11.

The colored backlights 11 are projected onto the liquid crystal optical gate 20. The liquid crystal optical gate 20 has a light blocking state and a light permeable state. The controller 30 generates a timing signal 31. The timing signal 31 may be an alternating signal. The time interval of two opposite phases of the timing signal 31 is equal to the time interval to emit the red backlight 111, green backlight 112 and blue backlight 113 once. The timing signal 31 switches the liquid crystal optical gate 20 into the light blocking state or the light permeable state, whereby the liquid crystal optical gate 20 has a light transmission curve 21. The light transmission curve 21 has an open delay interval 211 and a close delay interval 212 in the transitions of the light blocking state and the light permeable state. The timing signal 31 makes the close delay interval 212 coincide with the dark interval 12.

When the present invention generates pure-color lights with the light transmission curve 21 designated by r, g and b in FIG. 4, or when the present invention generates mixed-color lights with the light transmission curve 21 designated by c, m and y in FIG. 4, the latter colored backlight is not emitted during the close delay interval 212 because the close delay interval 212 coincides with the dark interval 12. Therefore, the latter colored backlight does not mix with the former colored backlight.

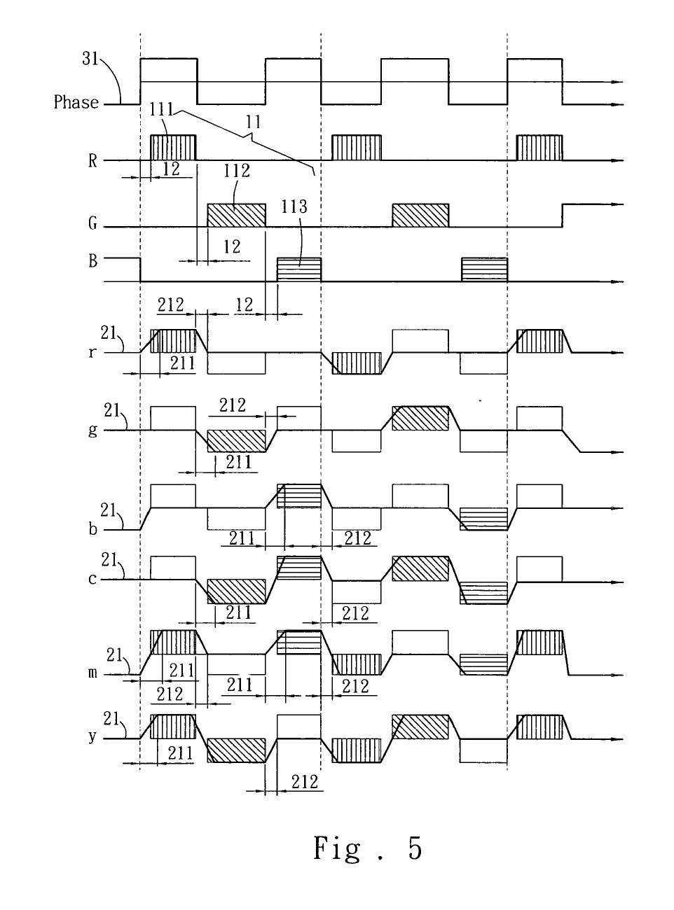

Refer to FIG. 5. In a second embodiment, the time point of switching two opposite phases of the timing signal 31 is identical to the time point of sequentially shifting the colored backlights 11. In such a mode, the three colored backlights 11 have almost identical light flux loss in the open delay interval 211 and close delay interval 212. Thus, no matter whether the present invention generates pure-color lights or mixed-color lights, the ratio of the component lights is almost identical to the ratio of the original design. Therefore, the present invention can present the designed colors correctly.

As described above, when generating pure-color lights the present invention can prevent the active colored backlight from mixing with another colored backlight 11 and avoids color deviation. When generating mixed-color lights, the present invention can present the designed colors correctly.

What is claimed is:

1. A color sequence offset modulation method comprising
providing a multi-color backlight source sequentially emitting at least two colored backlights with a dark interval therebetween;
providing a liquid crystal optical gate illuminated by said colored backlights and having a light blocking state and a light permeable state; and
providing a timing signal to switch said liquid crystal optical gate to said light blocking state or said light permeable state, whereby said liquid crystal optical gate has a light transmission curve, wherein said light transmission curve has an open delay interval and a close delay interval in transitions of said light blocking state and said light permeable state, and wherein said timing signal makes said close delay interval coincide with said dark interval.

2. The color sequence offset modulation method according to claim 1, wherein said colored backlights sequentially emits a red backlight a green backlight and a blue backlight: said timing signal is an alternating signal; a time interval of two opposite phases of said timing signal is equal to a time interval to emit said red backlight, said green backlight and said blue backlight once.

3. The color sequence offset modulation method according to claim 1, wherein said colored backlights sequentially emits a red backlight, a green backlight and a blue backlight; said timing signal is an alternating signal; a time point of switching two opposite phases of said timing signal is identical to a time point of sequentially shifting said colored backlights.

4. The color sequence offset modulation method according to claim 1, wherein said colored backlights have said dark intervals at the instant that said multi-color backlight source begins to emit said colored backlights.

5. A color sequence offset modulation device comprising
a multi-color backlight source sequentially emitting at least two colored backlights with a dark interval therebetween;
a liquid crystal optical gate illuminated by said colored backlights and having a light blocking state and a light permeable state; and
a controller providing a timing signal to switch said liquid crystal optical gate to said light blocking state or said light permeable state, whereby said liquid crystal optical gate has a light transmission curve, wherein said light transmission curve has an open delay interval and a close delay interval in transitions of said light blocking state and said light permeable state, and wherein said timing signal makes said close delay interval coincide with said dark interval.

6. The color sequence offset modulation device according to claim 5, wherein said colored backlights sequentially emits a red backlight, a green backlight and a blue backlight; said timing signal is an alternating signal; a time interval of two opposite phases of said timing signal is equal to a time interval to emit said red backlight, said green backlight and said blue backlight once.

7. The color sequence offset modulation device according to claim 5, wherein said colored backlights sequentially emits a red backlight, a green backlight and a blue backlight; said timing signal is an alternating signal; a time point of switching two opposite phases of said timing signal is identical to a time point of sequentially shifting said colored backlights.

8. The color sequence offset modulation device according to claim 5, wherein said colored backlights have said dark intervals at the instant that said multi-color backlight source begins to emit said colored backlights.
